(19) United States
(12) Patent Application Publication
(10) Pub. No.: US 2003/0236814 A1
(43) Pub. Date: Dec. 25, 2003

(54) Multitask control device and music data reproduction device

(76) Inventors: Shuji Miyasaka, Neyagawa-shi (JP); Tomokazu Ishikawa, Toyonaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/405,240

(22) Filed: Apr. 3, 2003

(30) Foreign Application Priority Data
Jun. 20, 2002 (JP) 2002-180629

(51) Int. Cl. G06F 9/00

(52) U.S. Cl. 709/102

(57) ABSTRACT

A multitask control device for causing a processor (10) to execute concurrently a plurality of tasks including a first task (101b) having a plurality of operation modes A˜C, the multitask control device including a task management device (20b) that judges whether the first task (101b) should be started up or not; and a mode setting unit (30b) that causes the processor (10) to execute the first task (101b) in the operation mode in which the first task (101b) has the highest function realized within the limit of the processor capacity of the processor (10), when the task management unit (20b) judges that the first task (101b) should be started up.

### TECHNICAL FIELD

The present invention relates to a multitask control device that causes a processor to execute a plurality of tasks concurrently, and a music data reproduction device.

### BACKGROUND ART

In recent years, a general-purpose digital signal processor (DSP) of a program control system which is capable of performing compression processing of data such as audio and video data at a high speed (285MIPS, for instance) has been developed, and used for a wide variety of devices such as modem, CD, MD, DVC and DVD devices as well as a digital cell phone and mobile AV equipment. A computer device incorporating such a processor, for example, a cell phone, realizes a telephone call function by causing the processor to execute a program for calling. However, there have been increasing user demands for the added functions of this cell phone, such as a music recording and/or reproducing device, a TV receiver, and even a device capable of concurrently recording music, watching TV and answering a phone if he/she gets a call. Therefore, there has been increasing tendencies to make this type of computers multifunctional by implementing a multitask control device capable of extending and modifying the functions easily so as to realize various functions.

This multitask control device causes a powerful processor to process three tasks concurrently, for example, a task for recording and/or reproducing music, a task for receiving TV and a task for a telephone call. These tasks are realized by the functions provided by a real time OS which runs on the processor, such as a task management unit which controls the startup and the stop of the tasks.

By the way, in order to meet the demands for recording and/or reproducing music, watching TV and making a telephone call at the same time, the spare capacity of the processor for recording and/or reproducing music is 35MIPS on the assumption that 150MIPS and 100MIPS load is put on the processor for processing the TV reception task and the telephone call task respectively.

That is why, traditionally, in order to avoid the processor from going out of capacity, a task with minimum number of commands for recording and/or reproducing music is created to control the load to within about 30MIPS so that recording and/or reproducing music, receiving TV and making a telephone call can be processed concurrently within the limit of the processing capacity of the processor.

There is an audio coding system for dividing a digital-audio signal into a plurality of frequency bands to code it in each band, as a conventional art (See Japanese Patent Application Laid-Open No.2000-78018, p. 1, FIG. 1). This audio coding system comprises a plurality of bit allocating means for performing bit allocation with different processing amount by generating bit allocation information for each of the divided bands, wherein bit allocation is executed, based on external control information, by switching among the plurality of means so that a predetermined one of the means is used for the bit allocation, for coding the digital-audio signal. By this system, real-time, non-interrupted and high-quality coded data creation is realized independently of CPU processing capacity in a computer and occupancy of other applications in the CPU.

However, even in this multitask control device or the music data reproduction device which implements this multitask control device in itself, it is a very rare case to do three actions, recording and/or reproducing music, watching TV and making a telephone call, at the same time. Only a single function of recording and/or reproducing music is usually used. When only a single function, recording and/or reproducing music, for instance, is used, the load of only 30MIPS is put on the processor for processing the music recording and/or reproducing task. In other words, the processor is used well within its capacity, with as much as 255MIPS processing capacity unused.

By the way, scalability in encoding and decoding audio signals is very high. For example, if the low load of 30MIPS or so with a small number of commands for encoding and decoding is put on the processor, the sound quality is very low, while if the higher load of 200MIPS or so with a larger number of commands for encoding is put on the processor, the sound quality becomes higher as much as the original sound.

Therefore, there is a problem traditionally that the sound quality is lower with the lower load on the processor because even the high capacity of the processor is not fully used.

In order to solve this problem, it is conceivable to make full use of the capacity of the processor to improve the sound quality by increasing the number of commands for the task of recording and/or reproducing music so as to put the load of 200MIPS on the processor for processing the task of recording and/or reproducing music.

However, in this case, if the user watches TV or makes a call during recording and/or reproducing music, the load goes beyond the processing capacity and the processor goes down.

Such a situation may occur regardless of a task type, and out-of-capacity/quality tradeoffs need to be considered.

The audio encoding method disclosed in the above-mentioned patent application is used under a CPU having processing capacity of several tens or hundreds of times as large as that of a processor in a cell phone, so above-mentioned problem seems to hardly occur. On the other hand, when there is no other choice but to use a processor of a several tenth or hundredth of a CPU used for a computer even if its processing capacity is improved than before, the above-mentioned problem is significant.

The present invention has been conceived in view of the traditional problem, and the object of the present invention is to provide a multitask control device and a music data reproduction device capable of improving quality and avoiding out-of-capacity of a processor with relatively low processing capacity.

### DISCLOSURE OF INVENTION

In order to solve the above-mentioned problem, the multitask control device according to the present invention is a multitask control device for causing a processor to execute concurrently a plurality of tasks including a first task having a plurality of operation modes, the multitask control device comprising: a judging unit operable to judge whether the first task should be started up or not; and a mode controlling unit operable to cause the processor to execute the first task in one of the operation modes in which the first task has a function realized within the limit of the processor capacity, when the judging unit judges that the first task should be started up. More specifically, the first task is a task for reproducing a digital audio signal, the function is a function of controlling sound quality, and the mode controlling unit may cause the processor to execute the first task in one of the operation modes in which the first task reproduces the signal with highest sound quality within the limit of the processor capacity, when the judging unit judges that the first task should be started up.

As a result, the range of choice for a function of the first task is broadened if the processor has spare capacity, while the range of choice is narrowed if the processor has no spare capacity. Therefore, the mode controlling unit can cause the processor to execute the first task in the operation mode in which the first task has the highest function realized within the limit of the processing capacity of the processor, and thus the out-of-capacity of the processor can be avoided without fail and the reproduced sound quality can be improved, regardless of the concurrence status of the tasks.

Here, the function is a highest function realized within the limit of the processor capacity, and the mode controlling unit may cause the processor to execute the first task in one of the operation modes in which the first task has the highest function. Also, the function becomes higher as load on the processor becomes larger, and the mode controlling unit may cause the processor to execute the first task in said one of the operation modes in which the first task operates in the largest load within the limit of the processor capacity, when the judging unit judges that the first task should be started up. In addition, the function becomes higher as the number of commands executed by the processor becomes larger, and the mode controlling unit may cause the processor to execute the first task in said one of the operation modes in which the first task operates according to the largest number of commands within the limit of the processor capacity, when the judging unit judges that the first task should be started up. Furthermore, the function is a filter function for controlling highest sound quality within the limit of the processor capacity, and the mode controlling unit may cause the processor to execute the first task in one of the operation modes in which the first task operates using the largest number of taps within the limit of the processor capacity, when the judging unit judges the first task should be started.

The mode controlling unit may include: a status change detecting unit operable to detect a status change of respective one of the tasks to be executed by the processor; a specifying unit operable to specify at least one of the tasks to be started up after the status change; and an operation mode determining unit operable to determine one of the operation modes for the first task if the first task is included in said at least one of the tasks specified by the specifying unit. Therefore, when the status change of the tasks occurs, the operation mode for the first task can be determined at appropriate timing.

In this case, the operation mode determining unit has an operation mode setting table in which said at least one of the tasks specified by the specifying unit and the operation mode for the first task to be started up after the status change are associated with each other, and the operation mode determining unit may determine said operation mode for the first task based on the operation mode setting table. Also, the operation mode determining unit has an operation mode setting table in which the number of the tasks specified by the specifying unit and the operation mode for the first task to be started up after the status change are associated with each other, and the operation mode determining unit may determine said operation mode for the first task based on the operation mode setting table. Therefore, the operation mode for the first task can be determined easily.

Furthermore, the operation mode determining unit includes: a load calculating unit operable to calculate load which is assignable to the execution of the first task to be started up after the status change; and a comparing unit operable to compare the load calculated by the load calculating unit and the load required for the execution of the first task in respective one of the operation modes, and the operation mode determining unit may determine the operation mode for the first task based on the result of comparison made by the comparing unit. In this case, the operation mode determining unit may further include: a startup request accepting unit operable to accept a startup request of respective one of the tasks; and a startup disabling unit operable to disable the startup of at least one other task than the first task if the load calculated by the load calculating unit is less than a threshold set for the operation mode with the lowest function for the first task, when the startup request accepting unit accepts the startup request of said at least one other task during the execution of the first task. Therefore, it is ensured that the first task is continuously processed in real time in the operation mode with the lowest function, and thus discontinuous reproduction of sound can be avoided. Also, the operation mode determining unit can further include: a startup request accepting unit operable to accept a startup request of respective one of the tasks; and a startup disabling unit operable to disable the startup of at least one other task than the first task, when the startup request accepting unit accepts the startup request of said at least one other task during the execution of the first task. Therefore, the change of the operation mode for the first task is avoided, and thus sound reproduction processing can be continued with constant sound quality.

In addition, the operation mode determining unit further includes: a command number calculating unit operable to calculate the number of commands which are assignable to the execution of the first task to be started up after the status change; and a comparing unit operable to compare the number of commands calculated by the command number calculating unit and the number of commands required for the execution of the first task in respective one of the operation modes, and the operation mode determining unit may determine the operation mode for the first task based on the result of comparison made by the comparing unit. In this case, the operation mode determining unit can further include: a startup request accepting unit operable to accept a startup request of said respective one of the tasks; and a disabling unit operable to disable the startup of at least one other task than the first task if the number of commands calculated by the command number calculating unit is less than a threshold set for the operation mode with the lowest function for the first task, when the startup request accepting unit accepts the startup request of said at least one other task during the execution of the first task. Therefore, it is also ensured that the first task is continuously processed in real time in the operation mode with the lowest function of the first task, and thus discontinuous reproduction of sound can be avoided. Also, the operation mode determining unit can further include: a startup request accepting unit operable to accept a startup of said respective one of the tasks; and a disabling unit operable to disable the startup of at least one other task than the first task, when the startup request accepting unit accepts the startup request of said at least one other task during the execution of the first task. Therefore, the change of the operation mode for the first task is avoided, and thus sound reproduction processing can be continued with constant sound quality.

Furthermore, the mode controlling unit may set for the first task a parameter that is associated with the operation mode determined by the operation mode determining unit, and cause the processor to execute the first task in the operation mode corresponding to the parameter. Therefore, the operation mode for the first task can be easily transitioned by a simple process of setting a parameter, and thus the load and the number of commands can be changed.

In addition, in order to solve the above-mentioned problem, the music data reproduction device according to the present invention is a music data reproduction device comprising a multitask control device for causing a processor to execute concurrently a plurality of tasks including a music reproduction task having a plurality of operation modes, wherein the multitask control device includes: a judging unit operable to judge whether the music reproduction task should be started up or not; and a mode controlling unit operable to cause the processor to execute the music reproduction task in one of the operation modes in which the music reproduction task reproduces music with highest sound quality within the limit of processor capacity, when the judging unit judges that the first task should be started up. More specifically, the music data reproduction device has portability, and at least one other task than the music reproduction task which is executed concurrently by the processor can be one of TV view, browsing, e-mailing and telephone calling. Therefore, a device with high portability such as a cell phone can be used as a high quality music data reproduction device concurrently with TV view, browsing, e-mailing and telephone calling.

As described above, according to the present invention, when there is enough operational resources, high quality audio signal processing can be performed, and even if there is no spare operational resources, the use of the operational resources can be reduced and the processing can be performed with the highest sound quality within the limit of the processing capacity of the processor. Therefore, the practical value of the present invention is extremely high.

Note that the present invention can be realized as a multitask control method including steps executed by all the units included in the multitask control device, or as a program for having a computer function as these units. In addition, the program can, of course, be widely distributed via a recording medium such as a DVD and a transmission medium such as the Internet.

As further information about technical background to this application, Japanese Patent Application No. 2002-180629 filed Jun. 20, 2002 is incorporated herein by reference.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing the structure of a multitask control device 1a according to a first embodiment of the present invention.

FIG. 2 is a diagram showing relation between load on a processor 10 and sound quality in operation modes A˜C of a first task 101a as shown in FIG. 1.

FIG. 3 is a diagram showing the detailed structure of an operation mode setting table 31a as shown in FIG. 1.

FIG. 4A is a diagram showing relation between the processing capacity of the processor and the operation mode A of the first task 101a as shown in FIG. 1.

FIG. 4B is a diagram showing relation between the processing capacity of the processor and the operation mode B of the first task 101a as shown in FIG. 1.

FIG. 4B is a diagram showing relation between the processing capacity of the processor and the operation mode C of the first task 101a as shown in FIG. 1.

FIG. 5 is a diagram showing operation of the multitask control device 1a.

FIG. 6 is a diagram showing transition of load depending upon transition of a task.

FIG. 7 is a diagram showing transition of load depending upon transitions of tasks.

FIG. 8 is a diagram showing transition of load depending upon transitions of tasks.

FIG. 9 is a block diagram showing the structure of a multitask control device 1b according to a second embodiment of the present invention.

FIG. 10 is a diagram showing the detailed structure of an operation mode determining table as shown in FIG. 9.

FIG. 11 is a diagram showing an example of the external structure of a cell phone in which the multitask control device as shown in FIG. 9 is implemented.

FIG. 12 is a flowchart showing details of task startup and stop processing executed by a task management unit 20b and a mode setting unit 30b.

FIG. 13 is a flowchart showing subroutines of music reproduction task startup control processing (S30) as shown in FIG. 12.

FIG. 14 is a flowchart showing subroutines of other task startup control processing (S40) as shown in FIG. 12.

FIG. 15 is a flowchart showing subroutines of other task stop control processing (S80) as shown in FIG. 12.

FIG. 16 is a diagram showing transition of load depending upon transitions of tasks in a concurrence enabling mode.

FIG. 17A is a diagram showing an example of screen display on a cell phone, and specifically showing a display example while a music reproduction task is being executed.

FIG. 17B is a diagram showing an example of screen display on a cell phone, and specifically showing a display example while the music reproduction task and TV view are being executed concurrently.

FIG. 17C is a diagram showing an example of screen display on a cell phone, and specifically showing a display example while the music reproduction task, TV view and browsing are being executed concurrently.

FIG. 17D is a diagram showing an example of screen display on a cell phone, and specifically showing a display example when a request for viewing a video e-mail is received while the music reproduction task, TV view and browsing are being executed concurrently.

FIG. 18 is a diagram showing transition of load depending upon transitions of tasks in a concurrence disabling mode.

FIG. 19 is a diagram showing another detailed structure of the operation mode setting table.

### BEST MODE FOR CARRYING OUT THE INVENTION

The multitask control device according to the embodiments of the present invention will be explained below with reference to the figures.

(First Embodiment)

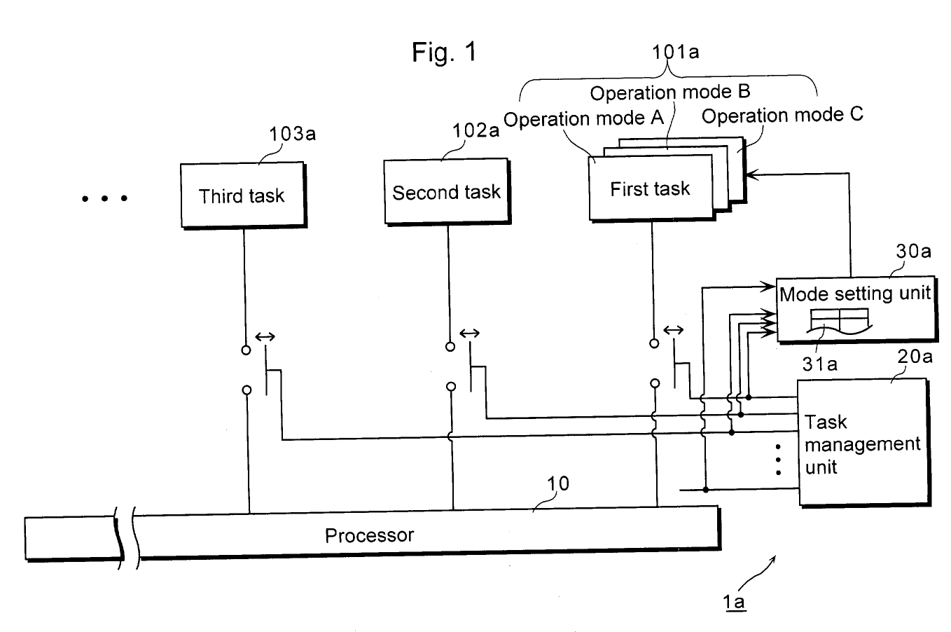

FIG. 1 is a block diagram showing the overall structure of the multitask control device 1a according to the first embodiment of the present invention.

The multitask control device 1a causes a processor 10 to process a plurality of (3 in this figure) tasks (including a first task 101a, a second task 102a and a third task 103a) respectively for making a cell phone multifunctional, for example. The multitask control device 1a includes a task management unit 20a and a mode setting unit 30a, and is realized by functions incorporated in a real time OS which runs on the processor 10.

The first task 101a processed by the processor 10 is one program for realizing a first function (music recording (audio signal encoding), for instance), and has three operation modes (an operation mode A, an operation mode B and an operation mode C) depending on three levels of sound quality, high, medium and low. These levels are determined by algorithms of tools used for encoding audio signals (such as a psychoacoustic model, TNS (Temporal Noise Shaping), prediction, M/S (Middle/Side) stereo, AAC quantization/encoding) which vary depending on values of parameters determined by the mode setting unit 30a, according to the standard of ISO/IEC 13818-7 Advanced Audio Coding (hereinafter referred to as “AAC”). In the operation mode A, more load than the operation mode B or C is put on the processor 10 so as to improve the sound quality. More specifically, as a result that the algorithms questing for higher sound quality are used in the order of the operation modes A, B and C, more operational amount (a larger number of commands) is required in this order, and thus more load is put on the processor 10 so as to reproduce sound of higher quality in this order.

More specifically speaking, when the parameter value is “1”, the first task 101a executes the operation mode A for putting the load N11 of 200MIPS on the processor 10. In this operation mode A, the first task 101a generates compressed audio data for reproducing top quality sound which is almost same as the original sound. When the parameter value is “2”, the first task 101a executes the operation mode B for putting the load N12 of 50MIPS on the processor 10. In this operation mode B, the first task 101a generates compressed audio data for reproducing medium quality sound which is slightly inferior to the sound reproduced in the operation mode A. And when the parameter value is “3”, the first task 101a executes the operation mode C for putting the load N13 of 30MIPS on the processor 10. In this operation mode C, the first task 101a generates compressed audio data for reproducing low quality sound which is slightly inferior to the sound reproduced in the operation mode B.

The second task 102a is a program for realizing the second function (TV reception, that is, video decoding (Vdec) and audio decoding (Adec), for instance) by putting the load N2 of 150MIPS per unit time, for instance, on the processor 10.

The third task 103a is a program for realizing the third function (telephone call, for instance (speech and echo cancel)) by putting the load N3 of 100MIPS per unit time, for instance, on the processor 10.

The processor 10 is a processor having capacity of processing one of the first˜third tasks 101a˜103a or a combination of two or more of them at a rate of 285MIPS=Nmax per unit time.

The task management unit 20a manages the startup and stop of each of the tasks 101a˜103a. More specifically, the task management unit 20a includes status codes indicating task status, a task control block (TCB) including a header address of each task, a flag at the time of interrupting processing and a register save area, a dispatcher and a scheduler. When an event occurs, such that a button for recording music is operated, a button for watching TV is operated, or an off-hook button is operated when getting a call, or the event ends, the task management unit 20a specifies tasks to be started next or stopped, detects the status change of the tasks to be processed by the processor 10 based on the specification, and then notifies the mode setting unit 30a of the detected status change of the tasks, or starts up or stops respective tasks 101a˜103a as scheduled using the TCB.

Upon receipt of the notification of the status change of the tasks, that is, the scheduled startup or stop of the tasks, from the task management unit 20a, if the first task 101a is included in the scheduled tasks, the mode setting unit 30a, having the operation mode setting table 31a, determines, with reference to the operation mode setting table 31a, the operation mode for the first task 101a depending on whether other tasks are to be executed concurrently with the first task 101a or not, and sets the parameter for the first task 101a based on the determined operation mode.

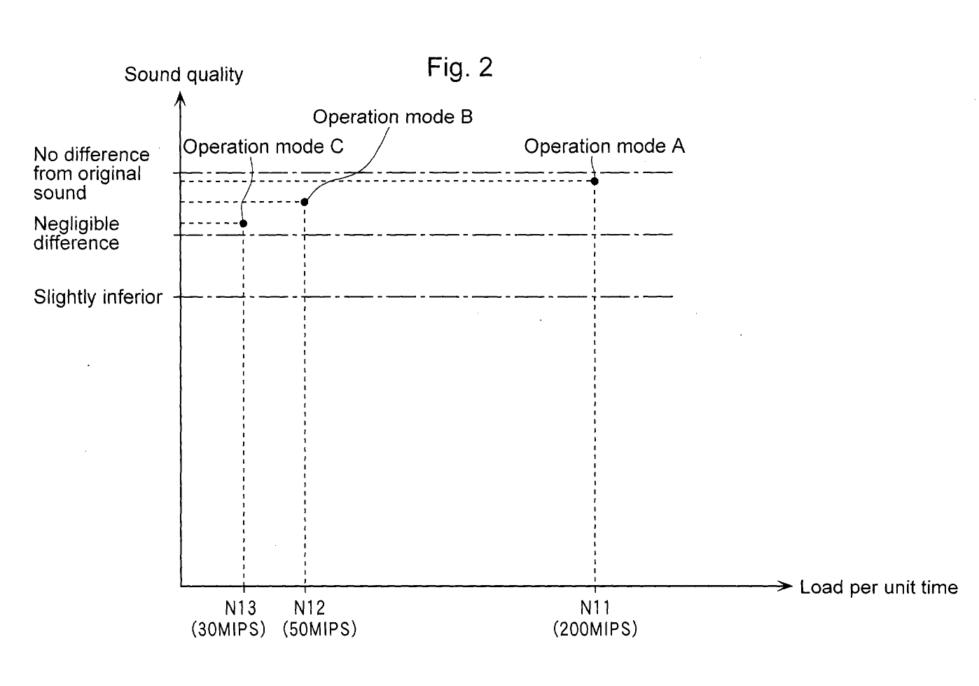

FIG. 2 is a diagram showing relation between load per unit time on a processor 10 and sound quality in the operation modes A˜C of the first task 101a as shown in FIG. 1.

AAC has a scalable structure so as to reproduce sound even if a part of a bit stream of an encoded audio signal is used, and in AAC, an algorithm questing for top quality can be adopted like a professional-grade encoder by combining a plurality of different algorithms, that is, all the tools, or an algorithm for lower quality than the professional-grade encoder, like an SD player, or an algorithm for still lower quality than the SD player, like an portable CD player, can be adopted by omitting a part of the tools (such as a prediction tool) or simplifying the tools.

For example, for high quality audio encoding, the processing called a psychoacoustic model imitating a masking phenomenon of human hearing is performed to improve the auditory sound quality (See AAC). However, an enormous number of commands are required for performing encoding processing for obtaining reproduced sound which is approximately same as the original sound, and thus a great deal of load is required for this encoding processing. On the contrary, if this processing is simplified, the sound quality is gradually lowered according to the simplification level, while the number of commands is sharply reduced, and thus the load required for this processing can be substantially reduced. In such a case, the program for performing encoding processing for obtaining reproduced sound which is approximately same as the original sound in full consideration of the psychoacoustic model is the operation mode A. The mode for performing the simplified processing of the first task is the operation mode B, and the mode for performing the still more simplified processing of the task is the operation mode C.

In addition, for high quality audio encoding, in order to suppress the compression distortion to the level as negligible for human hearing as possible, the encoding parameters are repeatedly changed or modified for compression (See AAC). This processing also requires a great deal of load. On the other hand, if this processing is simplified, the sound quality is gradually lowered according to the simplification level, while the load can be substantially reduced. In such a case, the mode for repeating change or modification of the encoding parameters many times is the operation mode A, and the modes for performing more simplified processing are the operation modes A and B.

More specifically, for the program of the operation mode A, the auditory characteristics are considered, such as variable minimum audible levels by frequency components (the so-called loudness characteristic), the masking characteristic, and insensitivity to absolute time deviation or phase lag. For example, the degree of raising levels in the lower and higher frequency bands is changed by changing the filter characteristic according to the audio signal levels, or the quantization noises are reduced by convoluting the audio signal along the line of the masking characteristic expressed in the Bark scale on the frequency axis (that is, the masking characteristic in which the masking range is narrowed in the lower frequency part and widened in the higher frequency part) according to the audio signal levels (amplitudes) and masking the lower level signal in the vicinity of the audio signal. Similarly, for the program of the operation mode B, the load per unit time is substantially reduced compared with that in the operation mode A by making the range of the masking characteristic same in both lower and higher frequency bands, for example. In addition, for the program of the operation mode C, the load per unit time is slightly reduced compared with that in the operation mode B by building up the levels in the lower and higher frequency bands using the same filter characteristic regardless of audio signal levels.

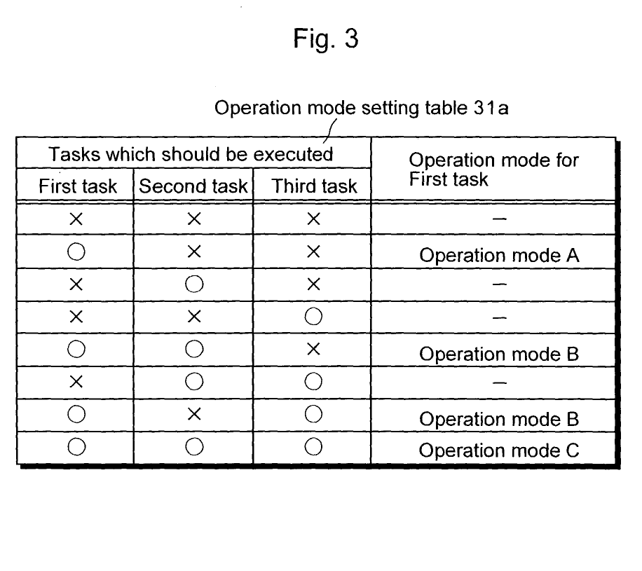

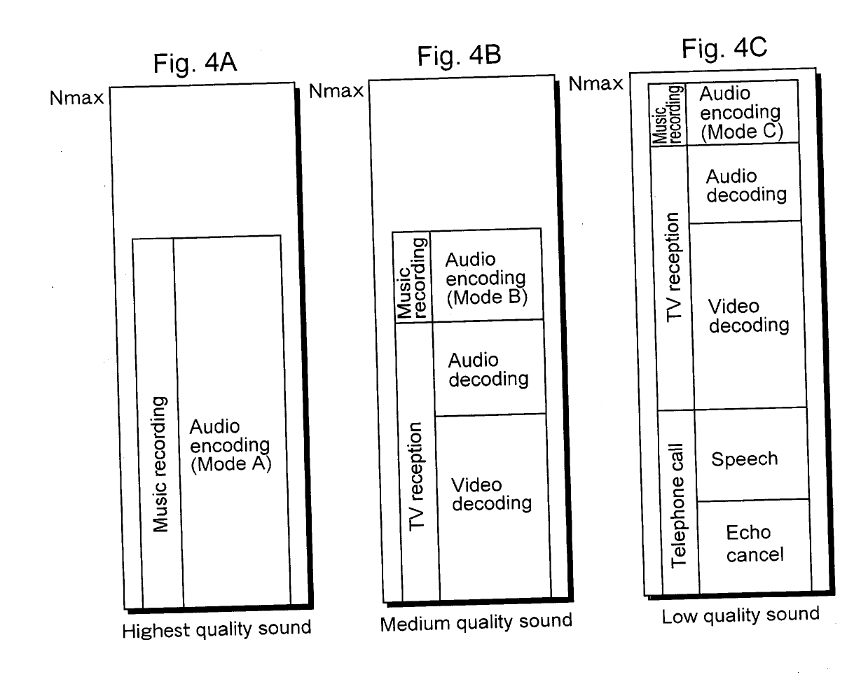

FIG. 3 is a diagram showing the detailed structure of the operation mode setting table 31a, and FIGS. 4A-4C are diagrams showing relations between the processing capacity of the processor and the operation modes A˜C for the first task 101a. Specifically, FIG. 4A shows the case where only the first task 101a is started up, FIG. 4B shows the case where the first task 101a and the second task 102a are started up concurrently, and FIG. 4C shows the case where the first task 101a, the second task 102a and the third task 103a are started up concurrently.

The operation mode setting table 31a in FIG. 3 shows the relation between the tasks which should be executed and the operation modes for the first task 101a to be executed. In this figure, “◯” indicates that the task is started up, “x” indicates that the task is stopped, and “−” indicates that no operation mode is set for the first task 101a. The case where the first task 101a is not started up is also shown in this figure.

This operation mode setting table 31a shows that when receiving the notification from the task management unit 20a that only the first task 101a is started up, the mode setting unit 30a sets the operation mode A with the highest load (the load N11 per unit time is 200IMPS, for instance) for the first task 101a. The reason why the operation mode A is set is as follows. If the processing capacity Nmax=285MIPS of the processor 10 is represented by blocks in FIG. 4A, all the capacity of the processor 10 can be assigned to the processing of the first task 101a. In this case, any of the operation modes A˜C can be set because they are within the limit of the processing capacity of the processor 10, but the sound quality in the operation mode A is highest among them. Therefore, the operation mode A with the highest quality is set to be executed for the first task 101a. In other words, the operation mode A is set to be executed with the highest quality within the limit that the processor 10 does not get out of capacity Also, this operation mode setting table 31a shows that when receiving the notification from the task management unit 20a that the second task 102a (150MIPS) and the first task 101a are started up concurrently, the mode setting unit 30a sets for the first task 101a the operation mode B (50MIPS) with the lower load than that of the operation mode A. The reason why the operation mode A is set is as follows. As shown in FIG. 4B, the load for processing the second task 102a accounts for N2=150MIPS among the processing capacity of the processor 10, and 135MIPS can be assigned to the processing of the first task 101a. So, any of the operation modes B and C can be set within the limit that the processor 10 does not get out of capacity, but the operation mode B is superior to the mode C in sound quality. Therefore, the operation mode B is set to be executed for the first task 101a. In other words, the operation mode B is set to be executed with the highest quality within the limit that the processor 10 does not get out of capacity.

Note that in this operation mode setting table 31a, when receiving the notification from the task management unit 20a that the third task 103a (100MIPS) and the first task 101a are started up concurrently, the mode setting unit 30a sets the operation mode B (50MIPS) for the first task 101a for the same reason as the case where the second task 102a (150MIPS) and the first task 101a are started up concurrently.

In addition, the operation mode setting table 31a shows that when receiving the notification from the task management unit 20a that all the first, second and third tasks 101a, 102a and 103a are started up concurrently, the mode setting unit 30a sets the operation mode C (the load N13 per unit time is 30MIPS, for instance) for the first task 101a. The operation mode C is set because only the mode C can be executed within the limit that the processor 10 does not get out of capacity. In other words, the operation mode C is set to be executed with the highest quality within the limit that the processor 10 does not get out of capacity.

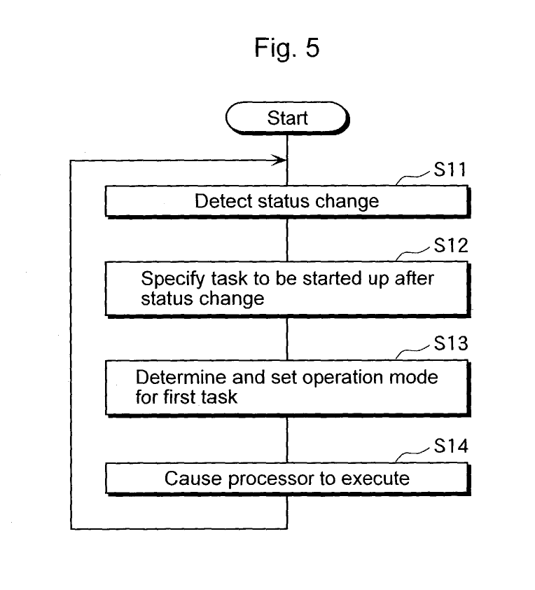

FIG. 5 is a diagram showing the operation of the multitask control device 1a.

When detecting a change of task status such as a new task startup and a task stop due to an event occurrence (S11), the task management unit 20a specifies the tasks to be started up after the status change (S12). Then, the task management unit 20a notifies the mode setting unit 30a of the tasks to be executed next based on this specification.

Upon receipt of the notification, the mode setting unit 30a determines the operation mode for the first task 101a using the operation mode setting table 31a if the tasks include the first task 101a, and sets the parameter corresponding to the determined operation mode for the first task 101a (S13). After setting the parameter for the first task 101a, the task management unit 20a causes the processor 10 to execute the tasks by time-sharing (S14).

By repeating these processes (S11˜S14), the multitask control device 1a concurrently processes the first-third tasks 101a˜103a by time-sharing so as to cause the processor 10 to execute the first task 101a in the top quality operation mode within the limit that the processor 10 does not get out of capacity, while improving the operating efficiency of the processor 10.

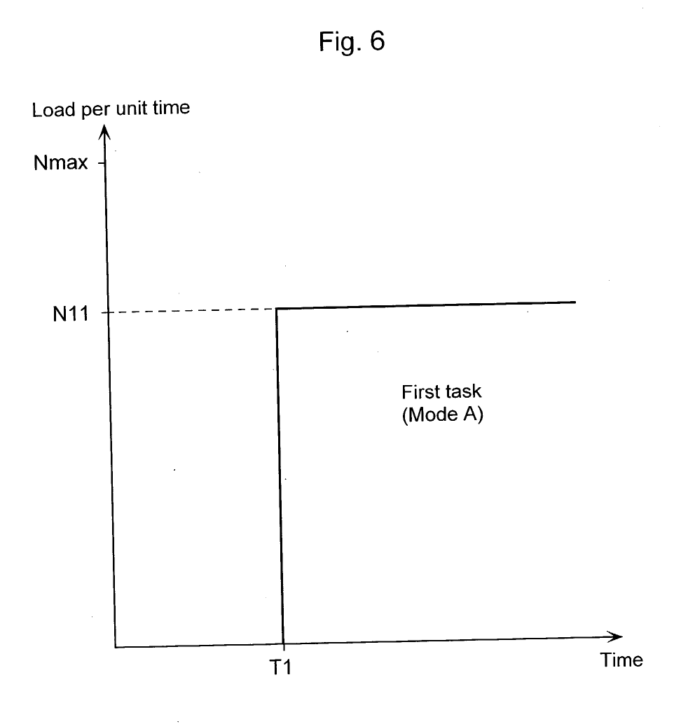

FIG. 6 is a diagram showing relation between the task status transition and the transition of the load on the processor 10 in the case where only the first task 101a is started up.

Before the time T1 shown in FIG. 6, no task is started up. In this status, if the task management unit 20a starts up only the first task 101a at the time T1, the mode setting unit 30a sets the parameter “1” for the first task 101a to cause the processor 10 to execute it in the operation mode A. At that time, the load on the processor 10 is N11=200MIPS, and the top quality sound can be obtained. In other words, since this load is well within the limit of the capacity of the processor 10, all of which can be assigned to the processing of the first task 101a, the mode setting unit 30a instructs the processor to execute the first task 101a in the operation mode A as a high quality encoding mode.

As described above, while the load of only 30MIPS is put on the processor 10 to reproduce low quality sound in the conventional art, the first task 101a is processed in the operation mode A for putting much more load of 200MIPS on the processor 10 in the first embodiment, and thus the operating efficiency of the processor 10 is drastically increased, which enables reproduction of top quality sound.

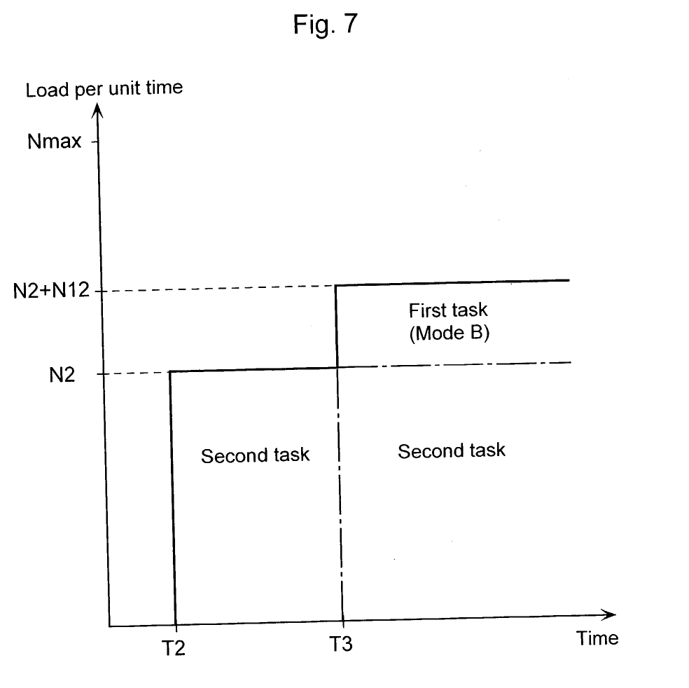

FIG. 7 is a diagram showing relation between the task status transition and the transition of the load on the processor 10 in the case where the first task 101a is further started up after the second task 102a has been started up.

If the task management unit 20a starts up only the second task 102a at the time T2 shown in FIG. 7, the load N2=150MIPS, which is required for the second task 102a, is put on the processor 10. Next, if the task management unit 20a further starts up the first task 101a at the time T3, the processing amount which can be assigned to the first task 101a is (Nmax−N2)=135MIPS because the processing of the second task 102a requires the load of 150MIPS. The operation mode setting table 31a as shown in FIG. 3 shows that the operation mode B (50MIPS) is designated for the first task 101a. According to this, the mode setting unit 30a determines the operation mode B and sets the parameter “2” for the first task 101a to cause the processor 10 to execute it in the operation mode B. In this case, the load N12 required for the operation mode B for the first task 101a is added to the processor 10. In other words, since the processor 10 here does not have so much spare capacity as that in the case of FIG. 7, the operation mode B with the highest quality within the limit that the processor 10 does not get out of capacity is set. Therefore, the operational load on the processor 10 is (N2+N12)=200MIPS.

Accordingly, while only the load of 30MIPS+150MIPS=180MIPS is put on the processor in the conventional art, as described above, much more load is put in the first embodiment to increase the operating efficiency of the processor 10, and thus the higher quality sound than ever before can be obtained.

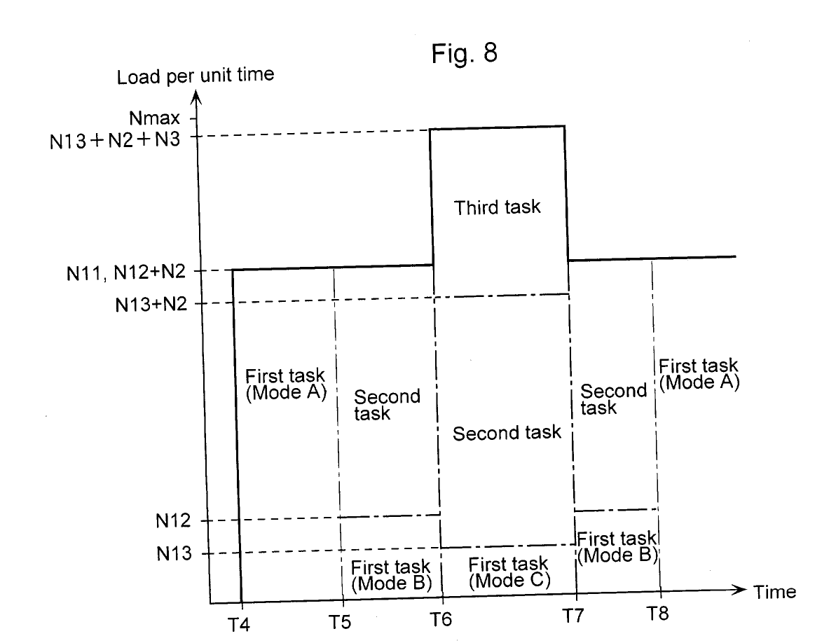

FIG. 8 is a diagram showing relation between the task status transition and the transition of the load on the processor 10 in the case where the second and third tasks 102a and 103a are further started up after the first task 101a has been started up.

Before the time T4 shown in FIG. 8, no task is started up. In this status, if the task management unit 20a starts up the first task 101a at the time T4, the mode setting unit 30a sets the operation mode A for the first task 101a because the second and third tasks 102a and 102a have not been started up. At that time, the load on the processor 10 is N11=200MIPS. In other words, since this load is well within the capacity of the processor 10, the mode setting unit 30a instructs the first task 101a to encode in the operation mode A as a high quality encoding mode.

Next, it is assumed that the task management unit 20a further starts up the second task 102a at the time T5. In this case, the operation load N2=150MIPS which is required for the second task 102a is added to the processor 10. In this case, if the operation mode A for the first task 101a is maintained as it is, the excessive load of 350MIPS is put on the processor 10, which causes the processor 10 to go down. So, the mode setting unit 30a determines the operation mode B (50MIPS) for the first task 101a, with reference to the operation mode setting table 31a. As a result, the total load of (N12+N2)=200MIPS is put on the processor 10. In other words, since the processor 10 here does not have so much spare capacity as assigning the operation mode A, the mode setting unit 30a instructs the first task 101a to encode in the operation mode B with the highest quality and the highest encoding speed within the limit that the processor 10 does not get out of capacity.

Next, it is assumed that the task management unit 20a starts up the third task 103a at the time T6. In this case, the load N3=100MIPS which is required for the third task 103a is added to the processor 10. If the operation mode B for the first task 101a is maintained as it is, the load on the processor 10 becomes 300MIPS, which causes the processor 10 to go out of capacity.

So, the mode setting unit 30a determines to set the operation mode C (30MIPS) for the first task 101a, with reference to the operation mode setting table 31a. As a result, the total load of (N13+N2+N3)=280MIPS is put on the processor 10.

In other words, since the processor 10 does not have so much spare capacity as assigning the operation mode B, the mode setting unit 30a instructs the first task 101a to encode in the operation mode C with the highest quality and high encoding speed but with less load within the limit that the processor 10 does not go out of capacity.

Next, it is assumed that the task management unit 20a stops the third task 103a (telephone call) at the time T7. In this case, since only the first and second tasks 101a and 102a are running, the mode setting unit 30a sets the operation mode B for the first task 101a, with reference to the operation mode setting table 31a. In other words, since the processor 10 has spare capacity in its operational load, the mode setting unit 30a instructs the first task 101a to encode in the operation mode B as a highest quality encoding mode within the limit that the processor 10 does not go out of capacity. As a result, the operational load on the processor 10 is (N12+N2)=200MIPS.

Next, it is assumed that the task management unit 20a stops the second task 102a at the time T8. In this case, since only the first task 101a is running, the mode setting unit 30a sets the operation mode A for the first task 101a. In other words, since the processor 10 has spare capacity in its operational load, the mode setting unit 30a instructs the first task 101a to encode in the operation mode A as a highest quality encoding mode. As a result, the operational load on the processor 10 is N11=200MIPS.

As described above, according to the first embodiment of the present invention, operation modes for putting different load values per unit time, for high, medium and low quality sound, on the processor 10, are prepared in advance for the first task 101a, and the mode setting unit 30a resets the operation mode for the first task 101a so as to put the highest load within the limit that the processor 10 does not go out of capacity whenever the status of the first and second tasks 101a and 102a in the task management unit 20a changes, that is, these tasks are respectively started up or stopped. More specifically, when a great deal of processing load is put on the processor 10 due to concurrent tasks, the processing load of the first task is reduced. Therefore, as long as the first task 101a is running, the load per unit time can be put on the processor 10 so that the load never exceeds the processing capacity Nmax of the processor 10. In other words, if the total load can be reduced and there is spare capacity to accept more load, a lot of processing resources can be assigned to the first task 101a to realize a high performance function. As a result, the operation mode with the highest load is set for the first task 101a within the limit of the capacity of the processor 10, which makes it possible to make full use of the processing capacity of the processor 10, and thus increase the operating efficiency of the processor 10.

In the first embodiment, the operation in the case where three tasks occur concurrently has been explained, but the present invention can be applied, based on the first embodiment, to the case where two tasks, or four or more tasks occur concurrently. Specifically, a plurality of operation modes, with different load values required for the processing per unit time, are switched for the first task, depending on the concurrence status of the tasks. The index for judging the switch of the operation modes for the first task is the total sum of the load of the running tasks other than the first task. If there is much spare capacity in the processor even with the total sum of the load being put on, the maximum load is given to the first task within that much spare capacity limit of the processor for high performance processing, and if there is not so much spare capacity in the processor with the total sum of the load being put on, the maximum load is given to the first task within such less capacity limit of the processor for high-speed processing.

In the first embodiment, the mode setting unit 30a determines the operation mode for the first task 101a using the operation mode setting table 31a, but the processing amount assignable to the first task 101a may be specified after the status change without using the operation mode setting table 31a so as to determine the operation mode for the first task for putting the highest load on the processor 10 within the limit that the processor 10 does not go out of capacity.

In the first embodiment, the total sum of the load of the running tasks other than the first task is used as an index for judging the switch of the operation modes for the first task, but it is possible to use the total sum of the operational amount required for the processing of the running tasks other than the first task, or the total number of commands included in the programs that form the running tasks other than the first task.

The number of the running tasks other than the first task may also be used. In this case, the operation mode may be determined and set in the manner as such the operation mode A for the number of other running tasks “0”, the operation mode B for “1” and the operation mode C for “2”. It is very easy to determine and set the operation mode.

In the first embodiment, three operation modes are available for the first task 101a, but two, or four or more operation modes may be used.

In the first embodiment, a plurality of operation modes with different load values are available for only the first task 101a, but they may be available for other tasks including the second task 102a. In this case, as an index for judging the switch of the operation modes, the number of concurrent tasks after the status change may be used.

In the first embodiment, the first task 101a includes one program for changing operation modes according to parameters. However, a plurality of the first tasks may include programs in the same category corresponding to different functions so as to select for the processor one task corresponding to the highest function within the limit of the processing capacity of the processor from among these first tasks, when it is judged that one of the first tasks should be started up. More specifically, it is assumed that when there have already been three programs in the same category, a professional-use encoder (200MIPS) for a DVD device or the like, an encoder or an SD jukebox (50MIPS) for an SD player or the like, and an encoder or a CD ripper (30MIPS) for a portable CD player or the like, the first tasks are these three programs; the professional-use encoder (200MIPS), the SD jukebox (50MIPS) and the CD ripper (30MIPS). When it is judged that one of the first tasks should be started up, one task corresponding to the highest function within the limit of the processing capacity of the processor may be selected for the processor from among the professional-use encoder (200MIPS), the SD jukebox (50MIPS) and the CD ripper (30MIPS).

In this case, there is no need to create one program for changing operation modes according to parameters, existing software can be reused, and thus recycling of existing resources are promoted.

In addition, in the first embodiment, the present invention is applied to the case where the first task is audio signal encoding, but it can be applied to audio signal reproduction. For example, the present invention may be applied to a virtual surround function in the audio signal reproduction. The virtual surround function is realized by a digital filter with a plurality of taps. For that purpose, if the program is formed so that the numbers of taps (the numbers of FIR filter coefficients) are 8192 (2 to the 13th power) for the operation mode A, 128 (2 to the 7th power) for the operation mode B, and 32 (2 to the 5th power) for the operation mode C, for instance, the operation mode A is set to put more load when concurrent tasks are few in number, and thus the virtual surround effect for enlarging the acoustic field can be maximized. On the contrary, when concurrent tasks are large in number, if the operation modes B and C are set in this order, the virtual surround effect can be gradually degraded.

(Second Embodiment)

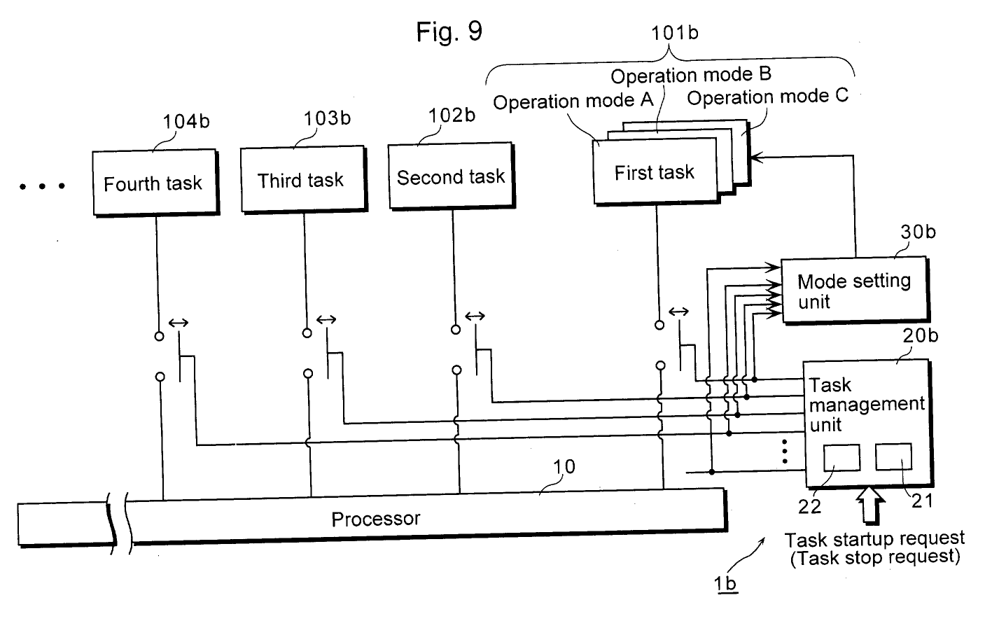

FIG. 9 is a block diagram showing the overall structure of a multitask control device 1b according to the second embodiment of the present invention. Note that the same numbers are assigned to the components corresponding to those of the multitask control device 1a in the first embodiment and the explanation thereof is omitted.

The multitask control device 1b has the approximately same structure as the multitask control device 1a in the first embodiment. For example, the multitask control device 1b, which causes the processor 10 to process a plurality of (four in this figure) tasks for making a cell phone multifunctional (a first task 101b, a second task 102b, a third task 103b and a fourth task 104b), includes a task management unit 20b and a mode setting unit 30b, and is realized by functions incorporated in a real time OS which runs on the processor 10.

The multitask control device 1a in the first embodiment is configured so as to execute the first task 101a and other tasks 102a and 103a concurrently, and the operation mode for the first task 101a is set based on the operation mode setting table 31a in the mode setting unit 30a. On the contrary, the multitask control device 1b in the second embodiment is configured so as to disable or enable the concurrence of the first task 101b and other tasks (the second task 102b, the third task 103b and the fourth task 104b) based on the user configuration, and the operation mode for the first task 101b is determined based on the operation mode determination table 22 in the task management unit 20b. This is a notable difference from the first embodiment. Note that the mode for disabling the concurrence of the first task 101b and the second-fourth tasks 102b˜104b is also hereinafter referred to as a “concurrence disabling mode”, and the mode for enabling the concurrence as a “concurrence enabling mode”.

The task management unit 20b includes a flag storage unit 21 for storing flags indicating the concurrence modes (the concurrence disabling mode and the concurrence enabling mode) set by a user, and an operation mode determination table 22 for determining the operation mode and the like for the first task 101b. If the flag stored in the flag storage unit 21 indicates the concurrence disabling mode, when a request is made for starting up other tasks after the first task 101b is started up, the task management unit 20b disables the startup of the other tasks. Similarly, if the flag indicates the concurrence enabling mode, when a request is made for changing the status of the current task, such as starting up or stopping it, and the tasks to be started up include the first task 101b, the task management unit 20b determines the operation mode for the first task 101b, based on whether the first task 101b and other tasks occur concurrently or not, with reference to the operation mode determination table 22, and notifies the mode setting unit 30b of the determined operation mode. Or, when the processing amount of the running first task 101b could drop to less than a predetermined threshold if the requested other tasks are started up, the task management unit 20b disables the startup of requested other tasks.

The mode setting unit 30b sets for the first task 101b the parameter corresponding to the operation mode notified by the task management unit 20b so as to execute the operation mode according to the parameter.

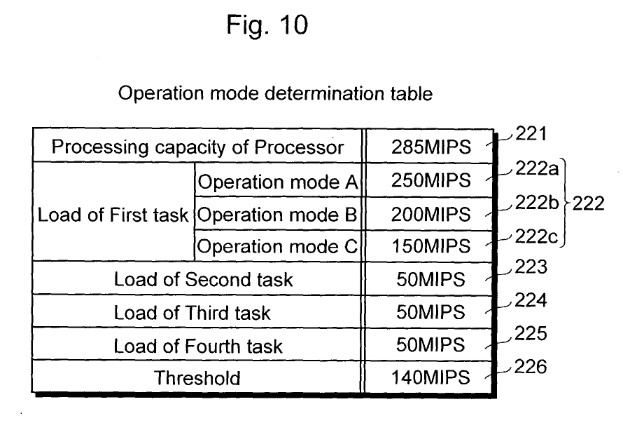

FIG. 10 is a diagram showing an example of the structure of the operation mode determination table 22 as shown in FIG. 9.

As shown in this figure, the operation mode determination table 22 includes a record 221 for storing the processing capacity of the processor 10, records 222˜225 for storing the load values of the first task 101b˜the fourth task 104b, and a record 226 for storing the threshold indicating the processing amount required minimally for executing the first task 101b.

The first task 101b processed by the processor 10 is one program for executing the first function (music reproduction), which decodes audio signals and changes the number of taps of a digital filter used for virtual surround reproduction according to the parameter values set by the mode setting unit 30b. The operation mode for the first task 101b, that is, the operation mode A, the operation mode B or operation mode C for reproducing sound with the level high, medium or low, is determined depending upon the number of filter taps. Specifically, the operation mode A is a program for performing virtual surround reproduction using a digital filter with 8192 taps after decoding, which puts the load of 250MIPS on the processor 10. The operation mode B is a program for performing virtual surround reproduction using a digital filter with 128 taps after decoding, which put the load of 200MIPS on the processor 10. The operation mode C is a program for performing virtual surround reproduction using a digital filter with 32 taps, which puts the load of 150MIPS on the processor 10.

The second task 102b is a program for decoding videos of digital satellite broadcasting and displaying them on a monitor (for TV view), which puts the load of 50MIPS on the processor 10. The third task 103b is a program for connecting to a desired server via the Internet to view (browse) the information uploaded on the server, which puts the load of 50MIPS on the processor 10. The fourth task 104b is a program for viewing video e-mails received via the Internet or the like, which puts the load of 50MIPS on the processor 10.

As a threshold, a value (140MIPS) which enables real-time decoding of audio data is set for reproducing sound continuously.

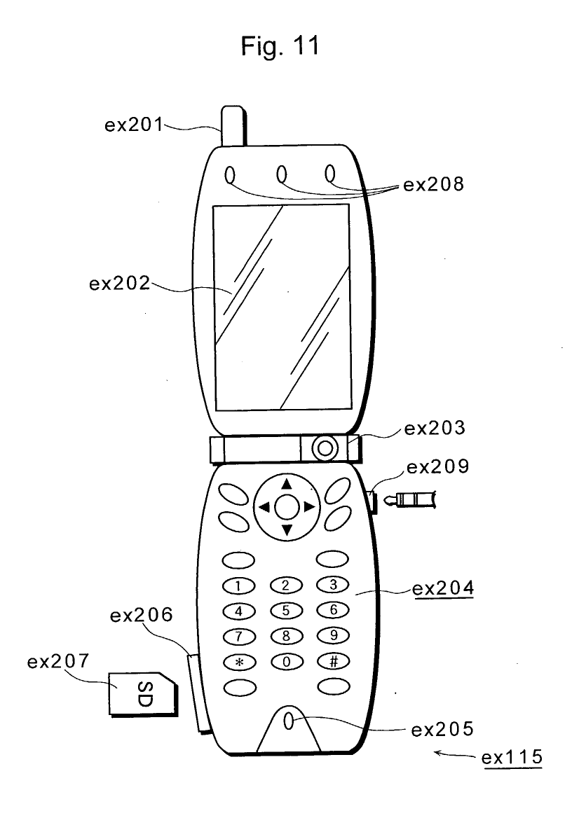

FIG. 11 is a diagram showing an example of the external structure of a cell phone in which the multitask control device 1b as shown in FIG. 9 is implemented.

As shown in this figure, a cell phone exit115 includes an antenna ex201 for transmitting and receiving radio waves between a cell site not shown in the figure and a satellite, an operation unit ex204 including a plurality of operation keys mounted on the body and operated by a user, a camera ex203 including a CCD camera or the like capable of shooting moving and still pictures, a display ex202 including a liquid crystal display or the like for displaying the pictures shot by the camera ex203, the TV videos and the like received via the antenna ex201, a voice input unit ex205 including a microphone for inputting voices, a voice output unit ex208 including a plurality of speakers for reproducing voices, a pin jack connector ex209 for connecting a headphone and an external speaker, a slot ex206 for inserting a recording medium ex207, and others.

Here, the recording medium ex207 is a plastic case such as an SD card containing a flash memory element, a type of EEPROM (Electrically Erasable and Programmable Read Only Memory) which is electrically rewritable and erasable nonvolatile memory, which holds the data of moving or still pictures, the data of received e-mails, the encoded audio data or decoded audio data, and others.

The task management unit 20b and the mode setting unit 30b included in the multitask control unit 1b are realized by a processor incorporated in the body of the cell phone ex115, a multitask OS executed by the processor, a ROM for storing application programs (such as software for an MPEG encoder/decoder, browser software and e-mail software), a memory for providing a work area for the running OS or application programs or for temporally memorizing flags indicating concurrence enabling/disabling set by the user and the operation mode determination table 22, and the like.

Next, the operation of the task management unit 20b and the mode setting unit 30b included in the multitask control device 1b will be explained below.

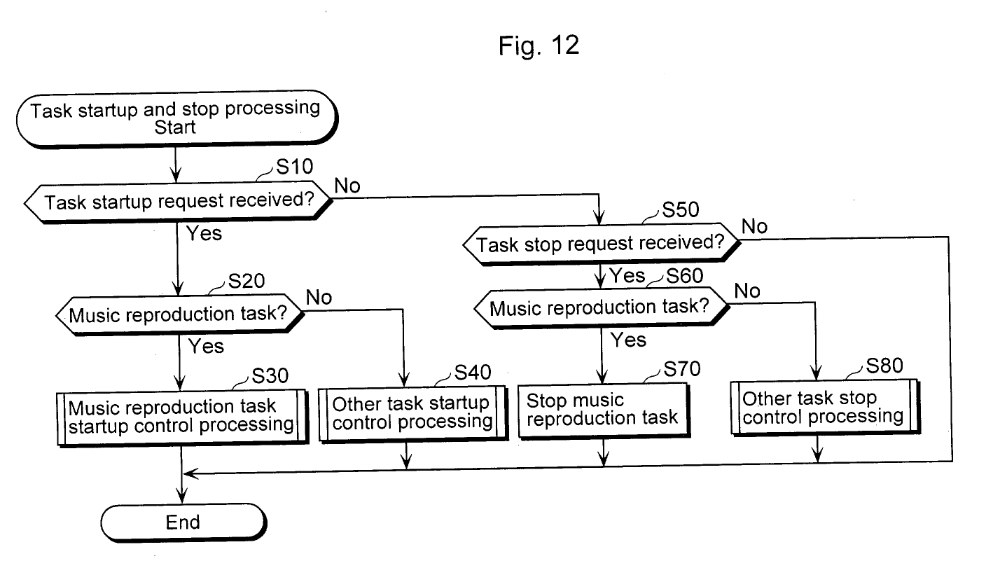

FIG. 12 is a flowchart showing the details of task startup and stop processing performed by the task management unit 20b and the mode setting unit 30b.

This task startup and stop processing is performed at predetermined time intervals.

In this processing, the task management unit 20b first judges whether a task startup request is received or not (S10). When the task startup request is received (Yes in S10), the task management unit 20b judges whether the task is a music reproduction task or not (S20). If it is the music reproduction task (Yes in S20), the task management unit 20b, in collaboration with the mode setting unit 30b, executes the music reproduction task startup control processing (S30) to end the task startup and stop processing. If the task is not the music reproduction task (No in S20), the task management unit 20b, in collaboration with the mode setting unit 30b, executes other task startup control processing (S40) to end the task startup and stop processing.

On the other hand, if the task startup request is not received (No in S10), the task management unit 20b judges whether a task stop request is received or not (S50). If the task stop request is received (Yes in S50), the task management unit 20b judges whether the task is the music reproduction task or not (S60). If it is the music reproduction task (Yes in S60), the task management unit 20b stops the music reproduction task (S70) to end the task startup and stop processing. If the task is not the music reproduction task (No in S60), the task management unit 20b, in collaboration with the mode setting unit 30b, executes other task stop control processing (S80) to end the task startup and stop processing.

If the task stop request is not received (No in S50), the task management unit 20b ends the task startup and stop processing.

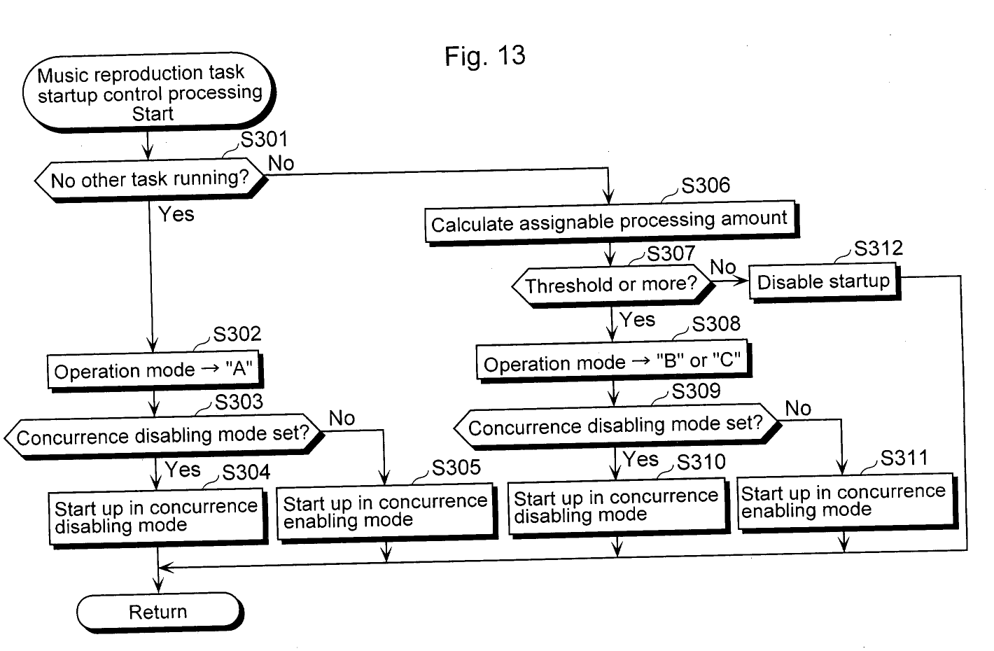

FIG. 13 is a flowchart showing subroutines of the music reproduction task startup control processing (S30) as shown in FIG. 12.

In this music reproduction task startup control processing, the task management unit 20b first judges whether there is another running task or not (S301). If there is no other task running (Yes in S310), the task management unit 20b determines the operation mode “A” (high quality) for the music reproduction task (S302) to make the mode setting unit 30b select the operation mode A. Then, the task management unit 20b judges whether the concurrent disabling mode is set or not with reference to the flag storage unit 21 (S303). If the concurrence disabling mode is set (Yes in S303), the task management unit 20b starts up the music reproduction task (operation mode “A”) in the concurrence disabling mode (S304) to return to the main routine. If the concurrence disabling mode is not set (No in S303), that is, if the concurrence enabling mode is set, the task management unit 20b starts up the music reproduction task in the concurrence enabling mode (S305) to return to the main routine.

On the other hand, if there is the other running task (No in S301), the task management unit 20b calculates the processing amount assignable to the music reproduction task (assignable processing amount) by subtracting the processing amount of the other task from the processing capacity of the processor 10 (S306), and judges whether or not the calculated assignable processing amount is the threshold or more (S307). If it is the threshold or more (Yes in S307), the task management unit 20b determines the operation mode “B” or “C” (medium or low quality) for the music reproduction task based on the assignable processing amount (S308) to make the mode setting unit 30b select the operation mode B or C. How to determine the operation mode is as follows. If the assignable processing amount is the processing amount of the operation mode B or more, the task management unit 20b determines the operation mode B, and if the assignable processing amount is less than that of the operation mode B, it determines the operation mode C. After determining the operation mode, the task management unit 20b judges whether the concurrence disabling mode is set or not (S309). If the concurrence disabling mode is set (Yes in S309), the task management unit 20b starts up the music reproduction task (operation mode “B” or “C”) in the concurrence disabling mode (S310) to return to the main routine. And if the concurrence disabling mode is not set (No in S309), the task management unit 20b starts up the music reproduction task (operation mode “B” or “C”) in the concurrence enabling mode (S311) to return to the main routine.

On the other hand, if the assignable processing amount is not the threshold or more, that is, less than the threshold (No in S307), the task management unit 20b disables the startup of the music reproduction task (S312) to return to the main routine. That is why real-time decoding cannot be performed even if the music reproduction task is started up and thus the music is reproduced discontinuously.

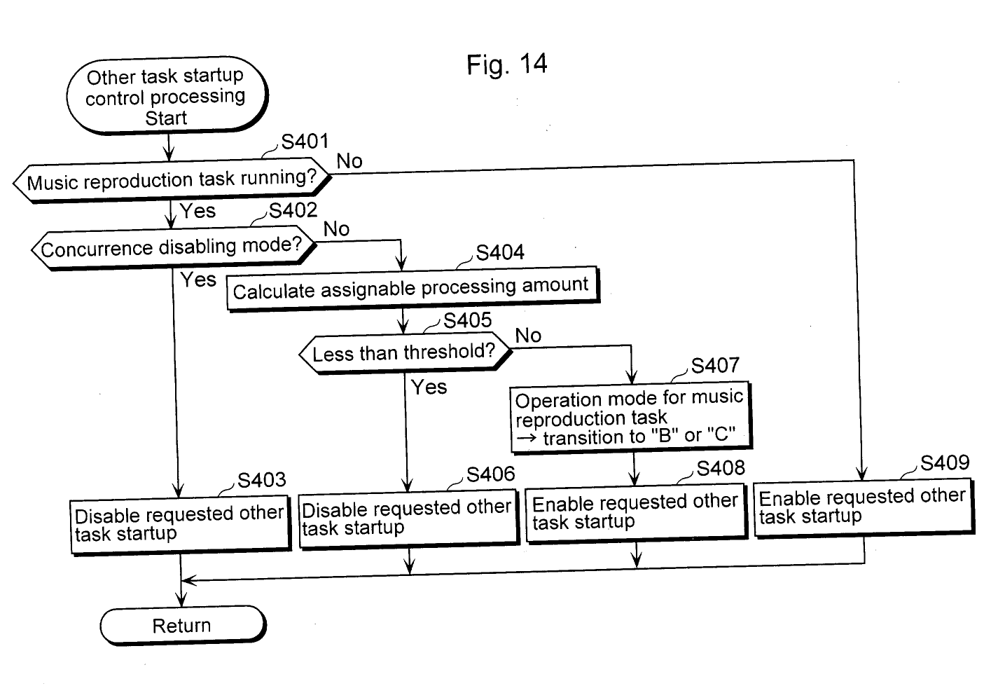

FIG. 14 is a flowchart showing the subroutines of the other task startup control processing (S40) as shown in FIG. 12.

When the other task startup request is received, the task management unit 20b first judges whether the music reproduction task is running or not (S401). If the music reproduction task is running as a result of the judgment (Yes in S401), the task management unit 20b judges whether this music reproduction task is running in the concurrence disabling mode or not (S402). If it is running in the concurrence disabling mode (Yes in S402), it disables the startup of the requested other task (S403) to return to the main routine. This processing does not change the operation mode for the running music reproduction task. So, the music reproduction is continued until the end with constant sound quality.

On the other hand, if the music reproduction task is not running in the concurrence disabling mode, that is, it is running in the concurrence enabling mode (No in S402), the task management unit 20b calculates the processing amount which is assignable to the music reproduction task (assignable processing amount) when the requested other task is started up, with reference to the operation mode determination table 22 (S404), and judges whether the calculated assignable processing amount is less than the threshold or not (S405). If it is less than the threshold (Yes in S405), the task management unit 20b disables the startup of the requested other task to return to the main routine. This processing ensures that the processing amount assignable to the music reproduction task is always the threshold or more. Therefore, the music is reproduced continuously. On the other hand, if the assignable amount is not less than the threshold, that is, it is the threshold or more (No in S405), the task management unit 20b determines the operation mode “B” or “C” for the music reproduction task based on the assignable processing amount calculated in Step S404, and the mode setting unit 30b transitions the operation mode to “B or “C” (S407). Specifically, the operation mode is transitioned in the following manner. If the assignable processing amount is the processing amount of the operation mode B or more, it is transitioned to the operation mode B, and if the assignable processing amount is less than that of the operation mode B, it is transitioned to the operation mode C. In this case, the operation mode is transitioned to that of the lower load, and thus the sound quality is degraded. After the operation mode is transitioned, the task management unit 20b enables the startup of the requested other task (S408) to return to the main routine. As a result, the music reproduction task and the requested other task are executed by time-sharing.

On the other hand, if the music reproduction task is not started up (No in S401), the task management unit 20b enables the startup of the requested other task (S409) to return to the main routine. As a result, the requested other task is executed.

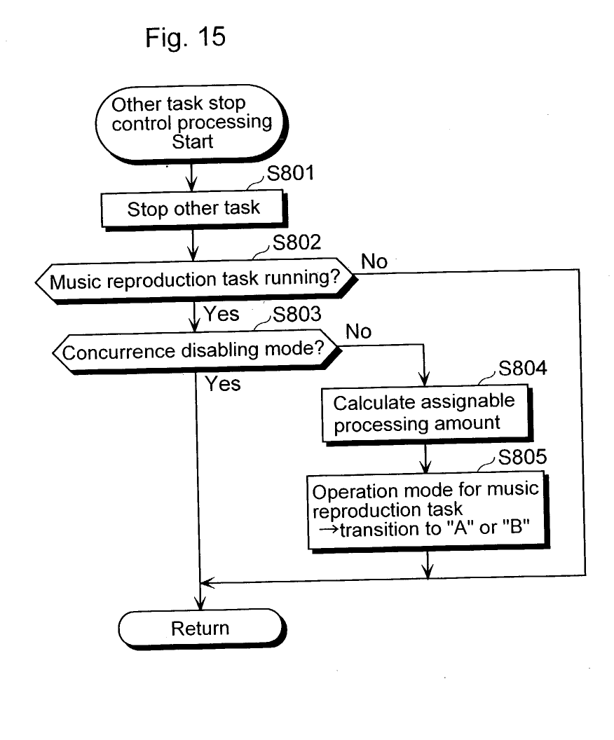

FIG. 15 is a flowchart showing the subroutines of the other task stop control processing (S80) as shown in FIG. 12.

When the other task stop request is received, the task management unit 20b first stops the other task (S801) and judges whether the music reproduction task is running or not (S802). If it is not running (No in S802), the procedure returns to the main routine.

If the music reproduction task is running (Yes in S802), the task management unit 20b judges whether the music reproduction task is running in the concurrence disabling mode or not (S803). If the task is running in the concurrence disabling mode (Yes in S803), the procedure returns to the main routine. In other words, the procedure returns to the main routine without allocating the spare processing capacity to the music reproduction task. Therefore, the operation mode for the running music reproduction task is not changed, and thus the music can be reproduced continuously without the change of the sound quality.

On the other hand, if the task is not running in the concurrence disabling mode (No in S803), that is, it is running in the concurrence enabling mode, the task management unit 20b calculates the processing amount assignable to the music reproduction task (assignable processing amount) (S804) and determines the operation mode “A” or “B” for the music reproduction task, and the mode setting unit 30b transitions the operation mode to “B” or “C” (S805), and then the procedure returns to the main routine. Specifically, the operation mode is transitioned in the following manner. If the assignable processing amount is the processing amount of the operation mode A or more, the operation mode is transitioned to “A”, and if it is less than that of the operation mode A, the operation mode is transitioned to “B”. In this case, since the operation mode is transitioned to that with heavier load, the sound quality is improved.

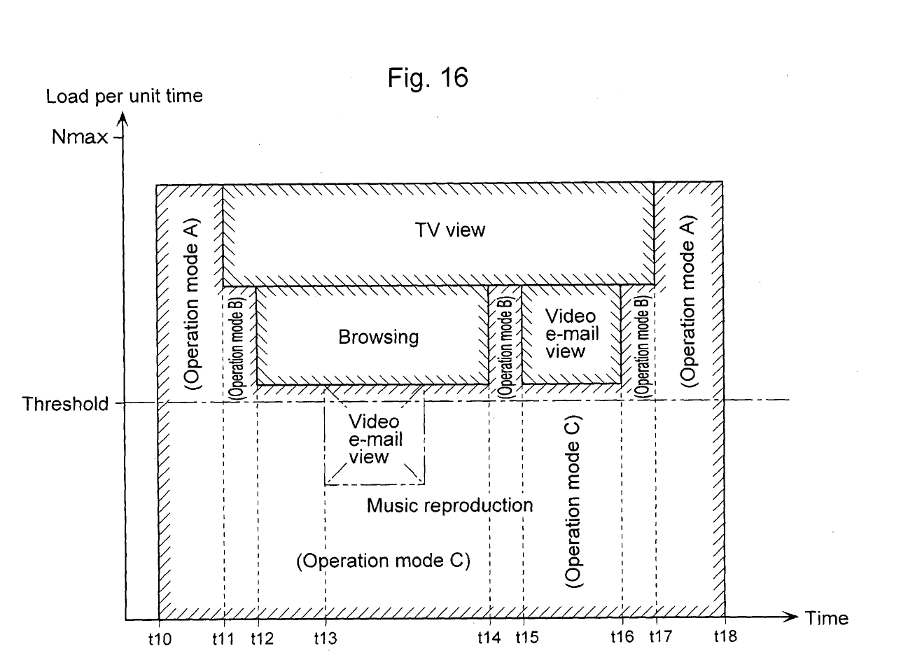

FIG. 16 is a diagram showing the transition of load depending upon the transition status of tasks in the concurrence enabling mode. Specifically, FIG. 16 shows the relation between the transition of task status and the transition of load on the processor 10 in the case where the music reproduction task is started up in the concurrence enabling mode and then other tasks are started up in sequence.

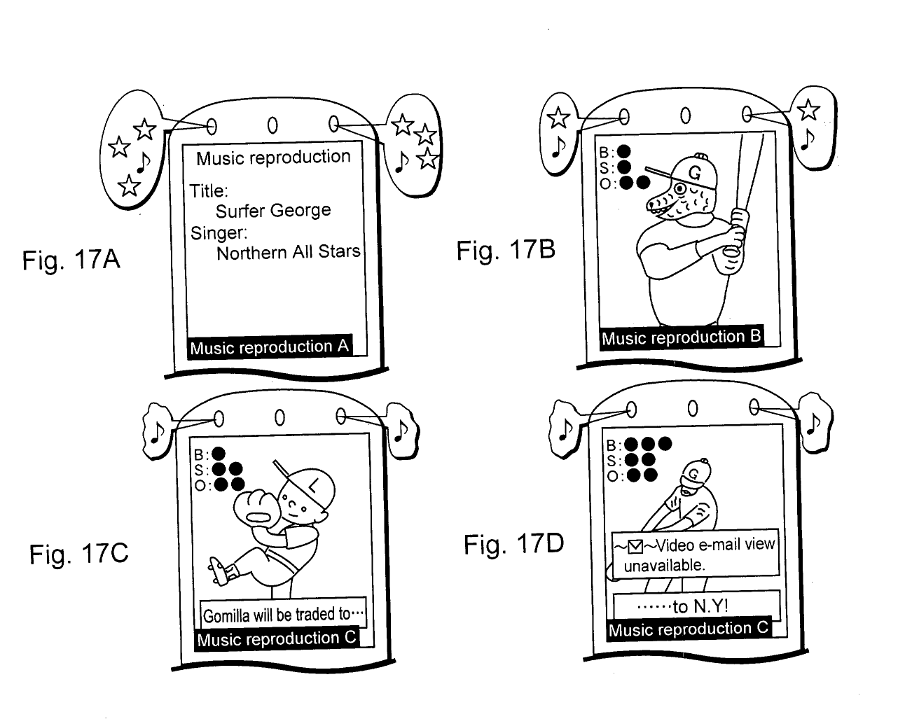

No task is started up before the time T10 as shown in FIG. 16. In this status, when the task management unit 20b starts up the music reproduction task at the time T10, no other task has not been started up. So, the mode setting unit 30b sets the operation mode A for the music reproduction task, and thus the load on the processor 10 is 250MIPS. In other words, since the processor 10 has spare capacity to accept more load, the parameter for reproducing music in the high quality virtual surround mode is set for the music reproduction task. When only the music reproduction task is executed like this, the operation mode “A”, the title of reproduced music, the singer, and others are displayed on the screen of the cell phone, as shown in FIG. 17A.

Next, it is assumed that the task management unit 20b starts up another task (TV view, for instance) at the time T11. In this case, the operational load, 50MIPS, required for the TV view is additionally put on the processor 10. If the operation mode A for the music reproduction task is maintained, the load on the processor 10 is 300MIPS, which is excessive and causes the processor 10 to go out of capacity. So, the task management unit 20b determines the operation mode “B” (200MIPS) with reference to the operation mode determination table 22, and causes the processor 10 to execute the music reproduction task in the operation mode B. As a result, the load of 250MIPS is put on the processor 10 in total. In other words, since there is no such spare capacity in the processor 10 to accept the load as in the case where only the operation mode A is put, the task management unit 20b causes the mode setting unit 30 to set the parameter for the music reproduction task so that music is reproduced in the highest quality operation mode within the limit of the capacity of the processor 10, that is, in the medium quality virtual surround mode. When the music reproduction task and TV view are concurrently running, the operation mode “B” as well as the TV broadcast of a baseball game are displayed on the screen, for example, as shown in FIG. 17B.

Next, it is assumed that the task management unit 20b starts up still another task (browsing, for instance) at the time T12. In this case, the operational load, 50MIPS, required for the browsing is additionally put on the processor 10. If the operation mode B for the music reproduction task is maintained, the load on the processor 10 is 300MIPS, which causes the processor 10 to go out of capacity. So, the task management unit 20b determines the operation mode “C” (150MIPS) with reference to the operation mode determination table 22, and causes the processor 10 to execute the music reproduction task in the operation mode C. As a result, the load of 250MIPS is put on the processor 10 in total. In other words, the task management unit 20b causes the mode setting unit 30 to set the parameter for the music reproduction task so that music is reproduced in the highest quality operation mode within the limit of the capacity of the processor 10, that is, in the low quality virtual surround mode. When the music reproduction task, TV view and browsing are concurrently running, the operation mode “C” as well as the TV broadcast of a baseball game and the information obtained by browsing are displayed on the screen, for example, as shown in FIG. 17C.

Next, it is assumed that the task management unit 20b receives a startup request of further another task (view of video e-mail, for instance) at the time T13. In this case, the operational load, 50MIPS, required for the e-mail view is additionally put on the processor 10. If the operation mode is further degraded from “C”, the load is less than the threshold, which causes discontinuous reproduction of music. So, the task management unit 20b disables the video e-mail view. As a result, the operation mode “C” for the music reproduction task is maintained, and thus the sound is reproduced continuously. In other words, if the startup is disabled when the video e-mail view request is received while the music reproduction task, TV view and browsing are concurrently running, the disabling reason or the like is displayed on the screen, for example, as shown in FIG. 17D.

Next, it is assumed that the task management unit 20b stops the browsing task at the time T14. In this case, since only the music reproduction task and TV view are started up, the task management unit 20b determines the operation mode “B” (200MIPS) with reference to the operation mode determination table 22, and causes the processor 10 to execute the music reproduction task in the operation mode B.

Next, it is assumed that the task management unit 20b starts up the video e-mail view at the time T15. In this case, the operational load, 50MIPS, required for the video e-mail view, is additionally put on the processor 10. So, the task management unit 20b determines the operation mode “C” (150MIPS) with reference to the operation mode determination table 22, and causes the processor 10 to execute the music reproduction task in the operation mode C.

Next, it is assumed that the task management unit 20b stops the video e-mail view at the time T16. In this case, since only the music reproduction task and TV view are started up, the task management unit 20b determines the operation mode “B” (200MIPS) with reference to the operation mode determination table 22, and causes the processor 10 to execute the music reproduction task in the operation mode B.

Next, it is assumed that the task management unit 20b stops the TV view at the time T17. In this case, since only the music reproduction task is started up, the task management unit 20b causes the processor 10 to execute the music reproduction task in the operation mode A. In other words, since there is spare capacity in the processor 10 to accept the load, the task management unit 20b causes the mode setting unit 30 to set the parameter for the music reproduction task so that music is reproduced in the high quality virtual surround mode.

Next, it is assumed that the task management unit 20b stops the music reproduction task at the time T18. In this case, since there is no task to be processed, the task management unit 20b causes the mode setting unit 30b to stop setting the operation mode for the music reproduction task, so as to stop all the tasks. In other word, the load on the processor 10 becomes “0” (idle), and thus the operational load on the processor 10 is “0” MIPS.

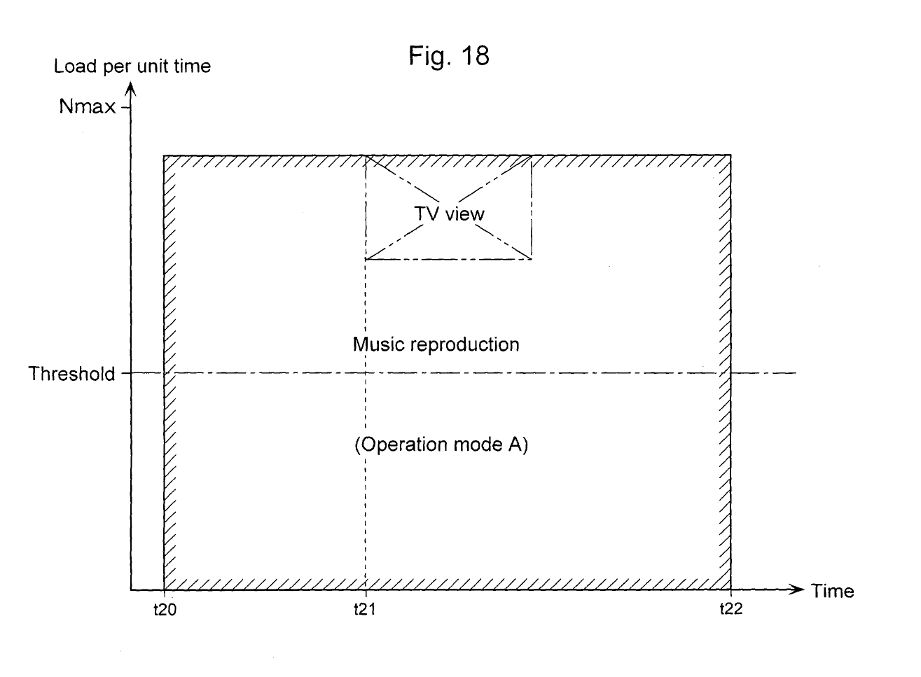

FIG. 18 shows a diagram showing the relation between the transition of task status and the transition of load on the processor 10 in the case where a startup request of another task is made after the music reproduction task is started up in the concurrence disabling mode.

Before the time T20 as shown in FIG. 18, no task is started up. In this status, if the music reproduction task is started up at the time T20, the task management unit 20b causes the processor 10 to execute the music reproduction task in the operation mode A since no other task is started up. In this case, since the processor 10 has spare capacity to accept the load, the task management unit 20b causes the mode setting unit 30b to set for the music reproduction task the parameter for reproducing music in the high quality virtual surround mode.

Next, it is assumed that the task management unit 20b receives a startup request of another task (TV view, for instance). In this case, since the music reproduction task is running in the concurrence disabling mode, the task management unit 20b disables the startup of the TV view. Therefore, the other task is not started up concurrently with the music reproduction task. Also, the mode setting unit 30b maintains the operation mode “A” for the music reproduction task. As a result, the sound quality is maintained constantly without change.

Next, it is assumed that the task management unit 20b stops the music reproduction task at the time T22. In this case, since there is no task to be processed, the task management unit 20b instructs the mode setting unit 30b to stop setting the operation mode for the music reproduction task so as to stop all the tasks. In other words, the load on the processor 10 is “0” (idle) in this case, and thus the operational load on the processor 10 is “0” MIPS.

As described above, according to the second embodiment, the operation modes, whose respective loads on the processor 10 per unit time are different to reproduce high, medium and low quality sound, are prepared. In the concurrence enabling mode, the task management unit 20b resets the operation mode for the music reproduction task so as to be the highest load within the limit of the processor's capacity at every status change such as the other task startup and stop. In other words, if a plurality of tasks are running concurrently and heavy processing load is put on the processor, the processing load for the music reproduction task is reduced within the limit of the threshold or more. Therefore, as long as the music reproduction task is running, the load per unit time can be put on the processor 10 without exceeding the processing capacity Nmbx of the processor 10. In sum, the total load can be reduced, and if there is spare load, multifunction can be realized while much processing resource is allocated to the music reproduction task. As a result, since the operation mode with the highest load is set for the music reproduction mode within the limit of the capacity of the processor, it becomes possible to make best use of the processing capacity of the processor, that is, to use the processor more efficiently. In addition, the other task is disabled to be started up if the processing amount of the music reproduction task is less than the threshold so as to reduce the processing load for the music reproduction task within the limit of the threshold or more, so the sound can be reproduced continuously.

Furthermore, when receiving the startup request of the other task after the music reproduction task is started up in the concurrence disabling mode, the task management unit 20b disables the other task to start up, so the reproduced sound quality is maintained until the end without change.

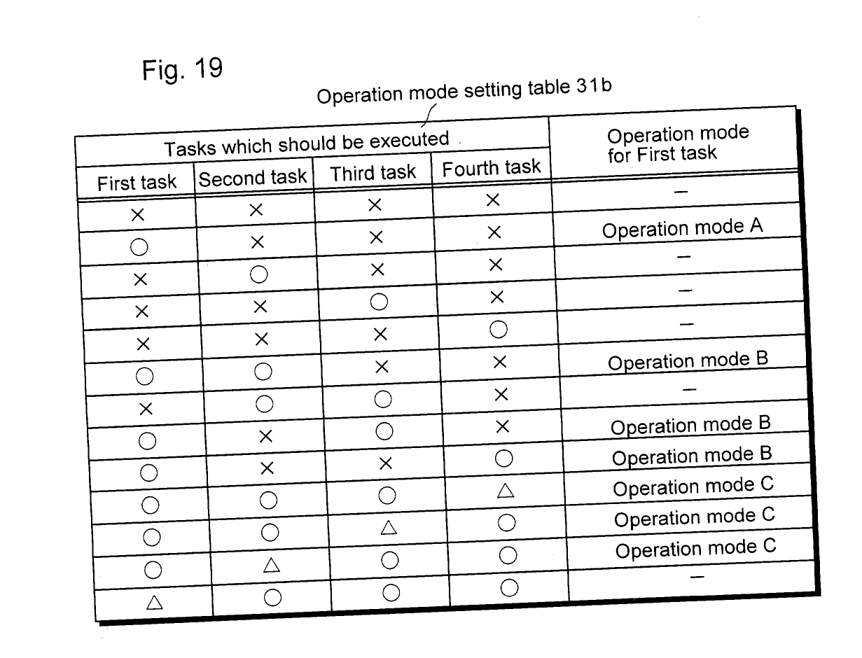

Note that, in the second embodiment, the task management unit 20b determines the operation mode for the first task 101b based on the operation mode determination table 22, but it may determine the operation mode for the first task 101b based on the operation mode setting table 31b as shown in FIG. 19. Just like the operation mode setting table 31a as shown in FIG. 3, in this operation mode setting table 31b, “603 ” shows a task startup status, “x” shows a task stop status, “−” shows that no operation mode is set for the first task 101b, and “Δ” shows that the startup is disabled, respectively. And FIG. 19 also shows the case where the first task 101 is not started up. The operation mode for the first task 101b can also be determined easily based on the operation mode setting table 31b.

This operation mode setting table 31b may be provided in the mode setting unit 30b. In this case, the task management unit 20b notifies the mode setting unit 30b of the status changes of the subject tasks, such as scheduled startup and stop of the tasks, in the concurrence enabling mode. If the first task 101b is included in the tasks to be started up, the mode setting unit 30b determines the operation mode for the first task 101b with reference to the operation mode setting table 31b and based on whether the tasks other than the first task 101b are to be started up concurrently or not, and sets the parameter for the first task 101b corresponding to the determined operation mode. Or, when the processing amount of the running first task 101b may be less than the threshold if the task management unit 20b starts up the requested other task, the mode setting unit 30b notifies the task management unit to disable the startup of the requested other task, and upon receipt of the notification, the task management unit 20b may disable the startup of the requested other task.

### INDUSTRIAL APPLICABILITY

The present invention is widely applicable to the case where a plurality of tasks are executed concurrently in real time not only in a digital cell phone and a mobile AV device, but also in a computer device equipped with a processor with relatively low processing capacity, such as a modem device, a CD device, an MD device, a DVC device and a DVD device.

1. A multitask control device for causing a processor to execute concurrently a plurality of tasks including a first task having a plurality of operation modes, the multitask control device comprising:
a judging unit operable to judge whether the first task should be started up or not; and
a mode controlling unit operable to cause the processor to execute the first task in one of the operation modes in which the first task has a function realized within the limit of the processor capacity, when the judging unit judges that the first task should be started up.

2. The multitask control device according to claim 1,
wherein the first task is a task for reproducing a digital audio signal,
the function is a function of controlling sound quality, and
the mode controlling unit causes the processor to execute the first task in one of the operation modes in which the first task reproduces the signal with highest sound quality within the limit of the processor capacity, when the judging unit judges that the first task should be started up.

3. The multitask control device according to claim 1,
wherein the function is a highest function realized within the limit of the processor capacity, and
the mode controlling unit causes the processor to execute the first task in one of the operation modes in which the first task has the highest function.

4. The multitask control device according to claim 3,
wherein the function becomes higher as load on the processor becomes larger, and
the mode controlling unit causes the processor to execute the first task in said one of the operation modes in which the first task operates in the largest load within the limit of the processor capacity, when the judging unit judges that the first task should be started up.

5. The multitask control device according to claim 3,
wherein the function becomes higher as the number of commands executed by the processor becomes larger, and
the mode controlling unit causes the processor to execute the first task in said one of the operation modes in which the first task operates according to the largest number of commands within the limit of the processor capacity, when the judging unit judges that the first task should be started up.

6. The multitask control device according to claim 1,
wherein the function is a filter function for controlling highest sound quality within the limit of the processor capacity, and
the mode controlling unit causes the processor to execute the first task in one of the operation modes in which the first task operates using the largest number of taps within the limit of the processor capacity, when the judging unit judges the first task should be started.

7. The multitask control device according to claim 1,
wherein the mode controlling unit includes:
a status change detecting unit operable to detect a status change of respective one of the tasks to be executed by the processor;
a specifying unit operable to specify at least one of the tasks to be started up after the status change; and
an operation mode determining unit operable to determine one of the operation modes for the first task if the first task is included in said at least one of the tasks specified by the specifying unit.

8. The multitask control device according to claim 7,
wherein the operation mode determining unit has an operation mode setting table in which said at least one of the tasks specified by the specifying unit and the operation mode for the first task to be started up after the status change are associated with each other, and
the operation mode determining unit determines said operation mode for the first task based on the operation mode setting table.

9. The multitask control device according to claim 7,
wherein the operation mode determining unit has an operation mode setting table in which the number of the tasks specified by the specifying unit and the operation mode for the first task to be started up after the status change are associated with each other, and
the operation mode determining unit determines said operation mode for the first task based on the operation mode setting table.

10. The multitask control device according to claim 7,
wherein the operation mode determining unit includes:
a load calculating unit operable to calculate load which is assignable to the execution of the first task to be started up after the status change; and
a comparing unit operable to compare the load calculated by the load calculating unit and the load required for the execution of the first task in respective one of the operation modes, and
the operation mode determining unit determines the operation mode for the first task based on the result of comparison made by the comparing unit.

11. The multitask control device according to claim 10,
wherein the operation mode determining unit further includes:
a startup request accepting unit operable to accept a startup request of respective one of the tasks; and
a startup disabling unit operable to disable the startup of at least one other task than the first task if the load calculated by the load calculating unit is less than a threshold set for the operation mode with the lowest function for the first task, when the startup request accepting unit accepts the startup request of said at least one other task during the execution of the first task.

12. The multitask control device according to claim 10,
wherein the operation mode determining unit further includes:
a startup request accepting unit operable to accept a startup request of respective one of the tasks; and
a startup disabling unit operable to disable the startup of at least one other task than the first task, when the startup request accepting unit accepts the startup request of said at least one other task during the execution of the first task.

13. The multitask control device according to claim 7,
wherein the operation mode determining unit further includes:
a command number calculating unit operable to calculate the number of commands which are assignable to the execution of the first task to be started up after the status change; and
a comparing unit operable to compare the number of commands calculated by the command number calculating unit and the number of commands required for the execution of the first task in respective one of the operation modes, and
the operation mode determining unit determines the operation mode for the first task based on the result of comparison made by the comparing unit.

14. The multitask control device according to claim 13,
wherein the operation mode determining unit further includes:
a startup request accepting unit operable to accept a startup request of said respective one of the tasks; and
a disabling unit operable to disable the startup of at least one other task than the first task if the number of commands calculated by the command number calculating unit is less than a threshold set for the operation mode with the lowest function for the first task, when the startup request accepting unit accepts the startup request of said at least one other task during the execution of the first task.

15. The multitask control unit according to claim 13,
wherein the operation mode determining unit further includes:
a startup request accepting unit operable to accept a startup of said respective one of the tasks; and
a disabling unit operable to disable the startup of at least one other task than the first task, when the startup request accepting unit accepts the startup request of said at least one other task during the execution of the first task.

16. The multitask control device according to claim 7,
wherein the mode controlling unit sets for the first task a parameter that is associated with the operation mode determined by the operation mode determining unit, and causes the processor to execute the first task in the operation mode corresponding to the parameter.

17. A program for having a computer function as a multitask control device for causing a processor to execute concurrently a plurality of tasks including a first task having a plurality of operation modes,
wherein the multitask control device comprises:
a judging unit operable to judge whether the first task should be started up or not; and
a mode controlling unit operable to cause the processor to execute the first task in one of the operation modes in which the first task has a function realized within the limit of processor capacity, when the judging unit judges that the first task should be started up.

18. A multitask control method for causing a processor to execute concurrently a plurality of tasks including a first task having a plurality of operation modes, the multitask control method comprising:
a judging step for judging whether the first task should be started up or not; and
a mode controlling step for causing the processor to execute the first task in one of the operation modes in which the first task has a function realized within the limit of processor capacity of the processor, when it is judged in the judging step that the first task should be started up.

19. A music data reproduction device comprising a multitask control device for causing a processor to execute concurrently a plurality of tasks including a music reproduction task having a plurality of operation modes,
wherein the multitask control device includes:
a judging unit operable to judge whether the music reproduction task should be started up or not; and
a mode controlling unit operable to cause the processor to execute the music reproduction task in one of the operation modes in which the music reproduction task reproduces music with highest sound quality within the limit of processor capacity, when the judging unit judges that the first task should be started up.

20. The music data reproduction device according to claim 19,
wherein the music data reproduction device has portability, and
at least one other task than the music reproduction task which is executed concurrently by the processor is one of TV view, browsing, e-mailing and telephone calling.
